(19) United States
(12) Patent Application Publication
(10) Pub. No.: US 2025/0368178 A1
(43) Pub. Date: Dec. 4, 2025

(54) VEHICLE CONTROL SYSTEM AND VEHICLE CONTROL DEVICE

(71) Applicant: Hitachi Astemo, Ltd., Hitachinaka-shi (JP)

(72) Inventor: Nobukazu Suzuki, Hitachinaka-shi (JP)

(73) Assignee: Hitachi Astemo, Ltd., Hitachinaka-shi (JP)

(21) Appl. No.: 19/171,427

(22) Filed: Apr. 7, 2025

(30) Foreign Application Priority Data
May 31, 2024 (JP) 2024-088763

(51) Int. Cl. B60W 10/22; B60W 50/14

(52) U.S. Cl. CPC B60W 10/22; B60W 50/14; B60W 2300/185; B60W 2510/225; B60W 2520/10; B60W 2540/106; B60W 2540/12

(57) ABSTRACT

In a vehicle control system S and a vehicle control device 100, when both a deceleration operation unit 52 and a starting operation unit 54 are operated while a vehicle 1 is stopped, a control unit 166 performs change control processing before the vehicle 1 starts, the change control processing changing one of a damping force of suspensions 30 and 40 and a vehicle height in a case where the one is controlled and changing both of the damping force of the suspensions 30 and 40 and the vehicle height in a case where the both elements are controlled.

### BACKGROUND OF THE INVENTION

The present invention relates to a vehicle control system and a vehicle control device.

In recent years, there has been proposed a configuration for a vehicle such as a four-wheeled automobile, which controls the operating state of a drive source of the vehicle, the driving state of the vehicle, the activated state of a component of the vehicle, and the like in accordance with whether an operation member such as a brake pedal and an accelerator pedal is operated by a driver and the operation amount.

Under such a circumstance, Japanese Patent Application Laid-open No. 2018-189062 relates to a control device for a vehicle and discloses a configuration achieving a brake override function that reduces the output of an internal combustion engine as a drive source of the vehicle when it is determined that an accelerator pedal and a brake pedal are pressed at the same time.

Japanese Patent Application Laid-open No. 2007-230462 relates to a brake device for a vehicle and discloses a configuration that, during sports driving in which the damping force of a damper is set to be higher to improve the turning performance of the vehicle, sets the jumping amount as the amount of rapidly increasing the braking force for an increase in the pedal force of a brake pedal to be large so as to increase the braking force to a level suitable for sports driving, and sets the damping force of the damper to be higher so as to prevent a nosedive of the vehicle body at the initial stage of braking.

### SUMMARY OF THE INVENTION

However, according to the studies by the present inventor, although Japanese Patent Application Laid-open No. 2018-189062 discloses a configuration aiming to perform the brake override function under broader circumstances, and Japanese Patent Application Laid-open No. 2007-230462 discloses a configuration aiming to obtain the braking characteristics suitable for both sports driving and normal driving, they fail to provide any disclosure or suggestion as to a specific configuration that enables a driver of the vehicle to start the vehicle smoothly and quickly when the driver starts the vehicle.

Further, according to the studies by the present inventor, although, in recent years, an automatic control function so-called launch control, which enables the driver to suddenly start and accelerate the vehicle being stopped while preventing a wheelspin in a mode in which a manual operation is simplified, has been applied to some vehicles, when the driver starts the vehicle that is a small and lightweight four-wheeled automobile such as a side-by-side vehicle while causing the launch control of the vehicle to function, the vehicle characteristics that a tendency of occurrence of a behavior causing a great change of attitude in the vehicle is increased by an instant increase in the driving force generated by the vehicle become apparent. Accordingly, it is eagerly awaited to achieve a configuration enabling the driver to start the vehicle smoothly and quickly.

The present invention has been made through the above studies and it is an object of the present invention to provide a vehicle control system and a vehicle control device that can achieve smooth and quick start of a vehicle.

In order to achieve the above object, one aspect of the present invention provides a vehicle control system comprising: a deceleration operation unit operated by a driver when a vehicle is to be decelerated; a starting operation unit operated by the driver when the vehicle is to be started; suspensions interposed between a vehicle body of the vehicle and wheels; and a control unit configured to control at least one of a damping force of the suspensions and a vehicle height of the vehicle, wherein when both the deceleration operation unit and the starting operation unit are operated while the vehicle is stopped, the control unit performs change control processing before the vehicle starts, the change control processing changing one of the damping force and the vehicle height in a case where the one is controlled and changing both of the damping force and the vehicle height in a case where the both elements are controlled.

Another aspect of the present invention provides a vehicle control device comprising: a first input unit to which first information indicating an operation amount of a deceleration operation unit operated by a driver when a vehicle is to be decelerated is input; a second input unit to which second information indicating an operation amount of a starting operation unit operated by the driver when the vehicle is to be started is input; a third input unit to which third information indicating a vehicle speed of the vehicle is input; a determination unit configured to determine whether the deceleration operation unit and the starting operation unit are operated while the vehicle is stopped, by using the first information, the second information, and the third information; and a control unit configured to control at least one of a damping force of suspensions interposed between a vehicle body of the vehicle and wheels and a vehicle height of the vehicle, wherein when the determination unit determines that the deceleration operation unit and the starting operation unit are operated while the vehicle is stopped, the control unit performs change control processing before the vehicle starts, the change control processing changing one of the damping force and the vehicle height in a case where the one is controlled and changing both of the damping force and the vehicle height in a case where the both elements are controlled.

According to the vehicle control system of one aspect of the present invention described above, when both a deceleration operation unit and a starting operation unit are operated while a vehicle is stopped, a control unit performs change control processing that changes one of a damping force and a vehicle height in a case where the one is controlled and that changes both the damping force and the vehicle height in a case where both are controlled, before the vehicle starts. Accordingly, the vehicle can be started smoothly and quickly. In particular, as for a small and lightweight vehicle employing launch control, it is possible to achieve a vehicle control system with a practical configuration that, when a driver of the vehicle starts the vehicle by using the launch control, can achieve an appropriate attitude of the vehicle while ensuring consistency with the launch control, thereby enabling the vehicle to start smoothly and quickly.

According to the vehicle control device of another aspect of the present invention, when a determination unit determines that a deceleration operation unit and a starting operation unit are operated while a vehicle is stopped, a control unit performs change control processing that changes one of a damping force of suspensions and a vehicle height in a case where the one is controlled and that changes both the damping force of the suspensions and the vehicle height in a case where both are controlled, before the vehicle starts. Accordingly, the vehicle can be started smoothly and quickly. In particular, as for a small and lightweight vehicle employing launch control, it is possible to achieve a vehicle control device with a practical configuration that, when a driver of the vehicle starts the vehicle by using the launch control, can achieve an appropriate attitude of the vehicle while ensuring consistency with the launch control, thereby enabling the vehicle to start smoothly and quickly.

### BRIEF DESCRIPTION OF THE DRAWINGS

FIG. 1 is a side view illustrating a right side of a vehicle on which a vehicle control system and a vehicle control device according to an embodiment of the present invention are mounted;

FIG. 2 is a schematic diagram illustrating a configuration of the vehicle control system and the vehicle control device according to the present embodiment; and

FIG. 3 is a side view illustrating an attitude of a vehicle when the vehicle control system and the vehicle control device according to the present embodiment are in operation, and corresponds to FIG. 1 in terms of position.

### DETAILED DESCRIPTION OF THE PREFERRED EMBODIMENTS

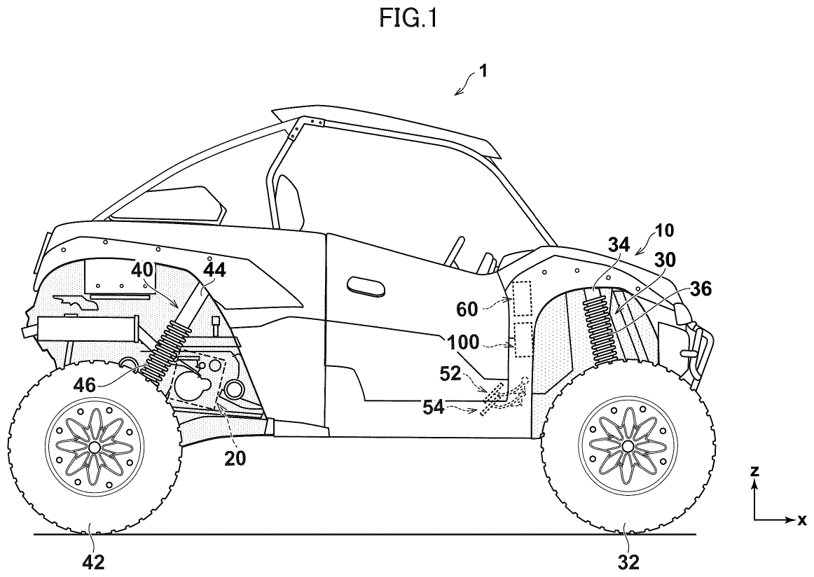

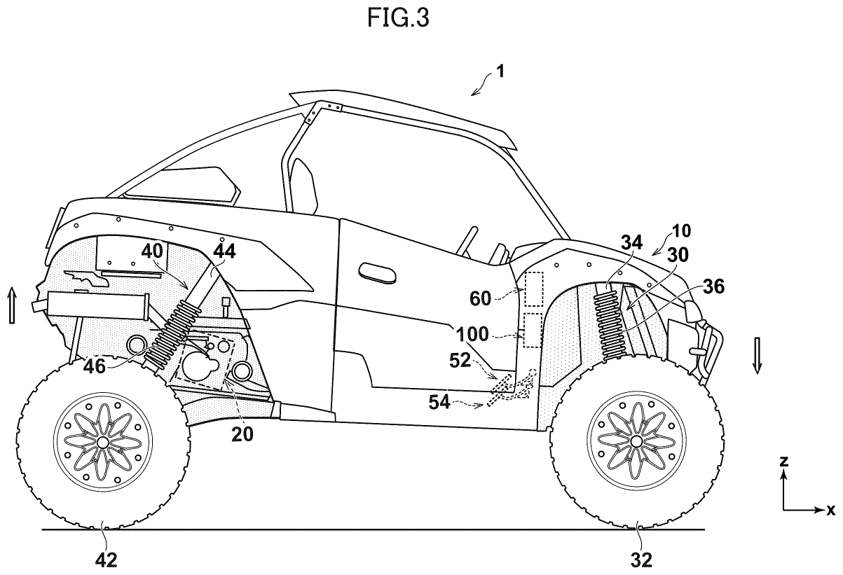

A vehicle control system and a vehicle control device according to an embodiment of the present invention are described below in detail with reference to the drawings as appropriate. In the drawings, an x-axis and a z-axis form a biaxial orthogonal coordinate system. Assuming the direction of the x-axis as the longitudinal direction and the traveling direction of a vehicle, the forward direction thereof is represented by the positive direction of the x-axis. Assuming the direction of the z-axis as the upper-lower direction of the vehicle, the upper direction thereof is represented by the positive direction of the z-axis. In addition, the direction crossing the x-axis and the z-axis at right angles is the width direction of the vehicle, and the left direction thereof corresponds to a direction penetrating through the drawings of FIGS. 1 and 3 from the near side to the far side.

### [Configuration Related to Vehicle]

First, with reference to FIG. 1, a configuration of a vehicle to which the positive direction of the y-axis is applied as the left direction of the width direction of the vehicle according to the present embodiment is explained in detail.

FIG. 1 is a side view illustrating a right side of a vehicle on which the vehicle control system and the vehicle control device according to the present embodiment are mounted. While only a front suspension, a front wheel, a rear suspension, and a rear wheel arranged on the right side are illustrated in FIG. 1, they are typically pairs of right and left parts, and a front suspension, a front wheel, a rear suspension, and a rear wheel are similarly arranged also on the left side.

As representatively illustrated in FIG. 1 as a side-by-side vehicle which is one type of small and lightweight four-wheeled off-road automobiles, a vehicle 1 typically includes a vehicle body 10 made of a metallic framework member such as an iron pipe material or an iron plate material (not illustrated), a drive source 20 that outputs a driving force of the vehicle 1, front suspensions 30 each interposed between the vehicle body 10 and a front wheel 32 to suspend the front wheel 32, and rear suspensions 40 each interposed between the vehicle body 10 and a rear wheel 42 to suspend the rear wheel 42, as main components. The vehicle 1 may be a vehicle called UTV (Utility Task Vehicle) or ROV (Recreational Off-highway Vehicle) as well as the vehicle called side-by-side vehicle. Alternatively, the vehicle 1 may be a three-wheeled automobile or the like as well as the four-wheeled automobile. An engine being an internal combustion engine, an electrical motor, or a combination of an engine and an electrical motor is applicable as the drive source 20. In the vehicle 1, it suffices that drive wheels are either the front wheels 32 or the rear wheels 42, or both thereof and steered wheels are only the front wheels 32 or both of the front wheels 32 and the rear wheels 42.

Each of the front suspensions 30 is electrically controlled and typically has an oil front damper 34, and a front spring 36 as a coil spring made of metal or the like. The front suspensions 30 are each capable of variably adjusting the damping force of the front damper 34 by activating an actuator (not illustrated) to increase or decrease the orifice diameter or the like of the front damper 34. As required, the front suspensions 30 are each additionally capable of variably adjusting the vehicle height that is the height of the vehicle body 10 from the road surface at a front side part of the vehicle 1 by increasing or decreasing the oil pressure, the oil supply amount or the like to change the stroke position in the bump direction or the rebound direction. Similarly, each of the rear suspensions 40 is electrically controlled and typically has an oil rear damper 44, and a rear spring 46 as a coil spring made of metal or the like. The rear suspensions 40 are each capable of variably adjusting the damping force of the rear damper 44 and, as required, are additionally capable of variably adjusting the vehicle height at a rear side part of the vehicle 1. While the front suspension 30 and the rear suspension 40 are illustrated as a strut type in FIG. 1, those of other forms having a configuration in which a damper and a spring are arranged on different shafts may be used.

The vehicle 1 is provided with a brake system (not illustrated). When a driver operates a brake pedal 52 attached to the vehicle body 10, a support member coupled to the vehicle body 10, or the like, the front wheels 32 and the rear wheels 42 are each controlled typically. The brake pedal 52 is an operation member (deceleration operation unit) that is typically pressed by the driver to actuate the brake system of the vehicle 1 and brake the front wheels 32 and the rear wheels 42. The brake pedal 52 may be replaced with an operation member such as a brake lever in accordance with the type or specification of vehicle.

In the vehicle 1, an accelerator pedal 54 is attached to the vehicle body 10, the support member coupled to the vehicle body 10, or the like in order to increase or decrease the driving force output from the drive source 20. The accelerator pedal 54 is an operation member (starting operation unit) that is pressed by the driver to control the operating state of the drive source 20. The accelerator pedal 54 may be replaced with an operation member such as accelerator lever in accordance with the type or specification of vehicle.

In the vehicle 1, a drive-source control device 60 that controls the operating state of the drive source 20 is attached to the vehicle body 10, the support member coupled to the vehicle body 10, or the like. The drive-source control device 60 operates with a battery (not illustrated) mounted on the vehicle 1 as a power supply and is mainly constituted of an ECU (Electronic Control Unit) that is an arithmetic processing device including a microcomputer or the like comprised of a CPU (Central Processing Unit) and the like. For example, when an engine is applied as the drive source 20, the drive-source (engine) control device 60 controls the activated states of constituent elements of a firing system, a fuel supply system, and an air intake system such as a spark plug, an injector, and a throttle valve (all not illustrated) to control the operating state of the drive source (engine) 20. When an electrical motor is applied as the drive source 20, the drive-source (motor) control device 60 controls the activated state, i.e., ON and OFF of a switching element of an inverter (not illustrated) to control the operating state of the drive source (motor) 20. The drive-source control device 60 can perform control processing for launch control that controls the operating state of the drive source 20 and/or a shift state of a transmission (not illustrated) when the vehicle 1 starts. A typical trigger condition for launch control is that the driver presses the brake pedal 52 and turns on a launch control switch (not illustrated) while the vehicle 1 is stopped and then, in a state where the driver presses the accelerator pedal 54 strongly while pressing the brake pedal 52, the driver stops pressing the brake pedal 52 and releases it. A typical termination condition for launch control is that the speed of the vehicle 1 (vehicle speed) reaches a predetermined value. A control program and control data to be used by the drive-source control device 60 are stored in advance in a memory (not illustrated), and are read from the memory at the time of execution.

### [Configuration and Operation Related to Vehicle Control System and Vehicle Control Device]

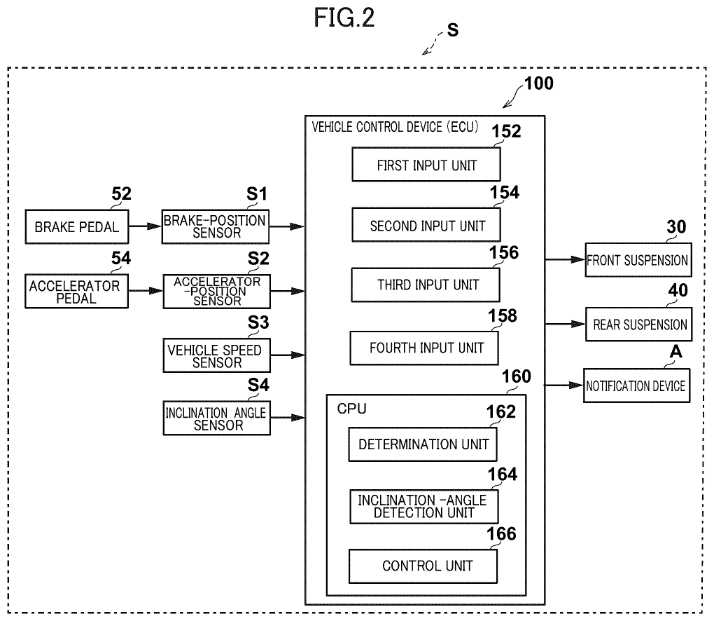

A configuration and an operation related to the vehicle control system and the vehicle control device according to the present embodiment are explained in detail next with reference also to FIGS. 2 to 3.

FIG. 2 is a schematic diagram illustrating a configuration of the vehicle control system and the vehicle control device according to the present embodiment. FIG. 3 is a side view illustrating an attitude of a vehicle when the vehicle control system and the vehicle control device according to the present embodiment are in operation, and corresponds to FIG. 1 in terms of position.

As illustrated in FIG. 2, a vehicle control system S includes a vehicle control device 100 and, associated therewith, includes the brake pedal 52, a brake-position sensor S1, the accelerator pedal 54, an accelerator-position sensor S2, a vehicle speed sensor S3, an inclination angle sensor S4, the front suspensions 30, the rear suspensions 40, and a notification device (notification unit) A.

The vehicle control device 100 operates with a battery (not illustrated) mounted on the vehicle 1 as a power supply and is mainly constituted of an ECU as an arithmetic processing unit including a microcomputer or the like comprised of a CPU 160 and the like. The brake-position sensor S1, the accelerator-position sensor S2, the vehicle speed sensor S3, the inclination angle sensor S4, the front suspensions 30, the rear suspensions 40, the notification device (notification unit) A, and the like are electrically connected to the vehicle control device 100. The vehicle control device 100 functions as a control device that variably controls the damping force and/or the stroke position of each of the front suspensions 30 and the rear suspensions 40 by executing a control program on the basis of electric signals output from those sensors and the like while referring to control data. The vehicle control device 100 has first to fourth input units 152 to 158, and a determination unit 162, an inclination-angle detection unit 164, and a control unit 166 in the CPU 160, which are respectively illustrated as functional blocks. The control program and the like are stored in a memory (not illustrated) in advance and are read from the memory at the time of execution. The vehicle control device 100 may be a control device integrated with the drive-source control device 60. In this case, the vehicle control device 100 functions as a control device that controls the operating state of the engine as the drive source 20, and also functions as a control device that variably controls the damping force and/or the stroke position of each of the front suspensions 30 and the rear suspensions 40. The vehicle control device 100 may be integrated with a dash-panel display control device and/or a vehicle-body control device.

The first input unit 152 is an electric circuit to which an electric signal that is output from the brake-position sensor S1 detecting the amount of pressing (operation amount) of the brake pedal 52 made by the driver and that indicates the detected pressing amount is input. A brake switch may be provided in place of the brake-position sensor S1 as required, which turns on when the pressing amount of the brake pedal 52 is equal to or more than a predetermined value. In this case, an electric signal indicating ON or OFF from the brake switch is input to the first input unit 152.

The second input unit 154 is an electric circuit to which an electric signal that is output from the accelerator-position sensor S2 detecting the amount of pressing (operation amount: accelerator opening degree) of the accelerator pedal 54 made by the driver and that indicates the detected pressing amount is input.

The third input unit 156 is an electric circuit to which an electric signal that is output from the vehicle speed sensor S3 detecting the rotation speed of a shaft on the output side of a transmission (not illustrated) of the vehicle 1 and that indicates the detected rotation speed is input. As required, the vehicle speed sensor S3 may detect the rotation speed of a wheel such as the front wheel 32 instead of the rotation speed of the shaft on the output side of the transmission.

The fourth input unit 158 is an electric circuit to which an electric signal that is output from the inclination angle sensor S4 detecting the inclination angle of the vehicle body 10 with respect to the horizontal plane and that indicates a value of the physical quantity corresponding to the inclination angle is input. The inclination angle sensor S4 detects the inclination angle of the vehicle body 10 with respect to the horizontal plane as a value of electrical conductivity or electrostatic capacity that is the physical quantity corresponding to the inclination angle.

The determination unit 162 calculates the pressing amount of the brake pedal 52 on the basis of the electric signal input to the first input unit 152, determines that the brake pedal 52 is pressed when the calculated pressing amount is equal to or more than a predetermined value, and determines that the brake pedal 52 is not pressed when the calculated pressing amount is less than the predetermined amount; calculates the pressing amount of the accelerator pedal 54 on the basis of the electric signal input to the second input unit 154, determines that the accelerator pedal 54 is pressed when the calculated pressing amount is equal to or more than a predetermined value, and determines that the accelerator pedal 54 is pressed when the calculated pressing amount is less than the predetermined value; and calculates the vehicle speed being the speed of the vehicle 1 on the basis of the electric signal input to the third input unit 156, determines that the vehicle 1 is stopped when the calculated vehicle speed is zero or is equal to or less than a predetermined value that can be evaluated as being substantially equivalent to zero, and determines that the vehicle 1 is not stopped when the calculated vehicle speed is higher than zero or the predetermined value that can be evaluated as being substantially equivalent to zero.

The inclination-angle detection unit 164 is a detection unit that detects a value of the physical quantity corresponding to the inclination angle of the vehicle body 10 with respect to the horizontal plane on the basis of the electric signal input to the fourth input unit 158, and also calculates the inclination angle of the vehicle body 10 with respect to the horizontal plane from the detected value. In a case where the inclination-angle detection unit 164 is provided, the determination unit 162 further determines that the vehicle 1 is not inclined when the inclination angle calculated by the inclination-angle detection unit 164 (the inclination angle of the vehicle body 10 with respect to the horizontal plane) is zero or within a predetermined range that can be evaluated as being substantially equivalent to zero (e.g., a range from −5° to +5°) or when the absolute value of that inclination angle is equal to or lower than a predetermined value (e.g., 5° that is the absolute value of −5° and +5°). Meanwhile, the determination unit 162 determines that the vehicle 1 is inclined when such conditions are not satisfied.

The control unit 166 variably controls the damping force of each of the front damper 34 and the rear damper 44 and/or the stroke position thereof for adjusting the vehicle height. Specifically, the control unit 160 performs change control processing changing the damping force of each of the front damper 34 and the rear damper 44 and/or the stroke position thereof for adjusting the vehicle height typically when the determination unit 162 determines that the vehicle 1 is stopped, the brake pedal 52 is pressed by the driver, and the accelerator pedal 54 is pressed by the driver.

At this time, from the perspective of preventing the attitude change of the vehicle 1 such as front lifting and rear dive, and the shift in dynamic center of gravity, it is preferable that the control unit 166 performs the change control processing changing the damping force of each of the front damper 34 and the rear bumper 44 to be increased first.

Further, from the perspective of anticipating the shift in dynamic center of gravity of the vehicle 1 and preventing the influence of that shift, it is preferable that the control unit 166 performs the change control processing changing the stroke position of the front damper 34 to the bump side in order to lower the vehicle height on the front wheel 32 side of the vehicle 1 so as to cause the vehicle 1 to take a crouching attitude. In addition, it is preferable that the control unit 166 performs the change control processing changing the stroke position of the rear damper 44 to the rebound side in order to raise the vehicle height on the rear wheel 42 side of the vehicle 1 so as to cause the vehicle 1 to take a crouching attitude. Furthermore, it is preferable that the control unit 166 performs the change control processing changing the stroke position of the front damper 34 to the bump side in order to lower the vehicle height on the front wheel 32 side of the vehicle 1 and changing the stroke position of the rear bumper 44 to the rebound side in order to raise the vehicle height on the rear wheel 42 side of the vehicle 1 so as to cause the vehicle 1 to take a deeper crouching attitude. FIG. 3 illustrates the attitude of the vehicle 1 in a state where the vehicle height on the front wheel 32 side of the vehicle 1 is lowered and the vehicle height on the rear wheel 42 side of the vehicle 1 is raised as a result of performing the change control processing by the control unit 166 which lowers the vehicle height on the front wheel 32 side of the vehicle 1 and raises the vehicle height on the rear wheel 42 side of the vehicle 1.

Further, in a case where the inclination-angle detection unit 164 is provided, the control unit 160 performs the change control processing changing the damping force of each of the front damper 34 and the rear damper 44 and/or the stroke position thereof for adjusting the vehicle height, when the determination unit 162 determines that the vehicle 1 is stopped, the brake pedal 52 is pressed by the driver, the accelerator pedal 54 is pressed by the driver, and the vehicle 1 is not inclined.

The notification device (notification unit) A presents notification information notifying the driver that the setting in the vehicle is to be changed, for example, visually. Specifically, in a case where the notification device A is provided, the control unit 160 activates the notification device A and causes the notification device A to present notification information notifying that the damping force of each of the front damper 34 and the rear damper 44 and/or the stroke position (vehicle height) is to be changed (the change control processing is to be performed) at the time of performing the change control processing changing the damping force of each of the front damper 34 and the rear damper 44 and/or the stroke position thereof, when the determination unit 162 determines that the vehicle 1 is stopped, the brake pedal 52 is pressed by the driver, and the accelerator pedal 54 is pressed by the driver, or when those conditions are satisfied and the determination unit 162 further determines the vehicle 1 is not inclined.

As is apparent from the above description, in a first aspect of the vehicle control system S according to the present embodiment, when both the deceleration operation unit 52 and the starting operation unit 54 are operated while the vehicle 1 is stopped, the control unit 166 performs change control processing that changes one of the damping force of the suspensions 30 and 40 and the vehicle height in a case where the one is controlled and changes both the damping force of the suspensions 30 and 40 and the vehicle height in a case where both are controlled, before the vehicle 1 starts. Accordingly, the vehicle 1 can be started smoothly and quickly. In particular, as for the vehicle 1 that is a small and lightweight vehicle employing launch control, it is possible to achieve a practical configuration that can achieve an appropriate attitude of the vehicle 1 with consistency with the launch control ensured, thereby enabling smooth and quick start of the vehicle 1, when a driver of the vehicle 1 starts the vehicle 1 by using the launch control.

In a second aspect of the vehicle control system S according to the present embodiment, in addition to the first aspect, the inclination-angle detection unit 164 detecting a physical quantity corresponding to the inclination angle of the vehicle body 10 with respect to the horizontal plane is further included, and the control unit 166 performs change control processing when the absolute value of the inclination angle obtained by using the physical quantity detected by the inclination-angle detection unit 164 is equal to or lower than a predetermined threshold. Accordingly, the vehicle 1 can be started more smoothly and more quickly.

In a third aspect of the vehicle control system S according to the present embodiment, in addition to the second aspect, the suspensions 30 and 40 include the first suspensions 30 each interposed between the vehicle body 10 and the front wheel 32 and the second suspensions 40 each interposed between the vehicle body 10 and the rear wheel 42, and the control unit 166 increases the damping force of the first suspensions 30 and increases the damping force of the second suspensions 40 in the change control processing. Accordingly, the attitude of the vehicle 1 when the vehicle 1 starts can be made more stable.

In a fourth aspect of the vehicle control system S according to the present embodiment, in addition to the third aspect, the control unit 166 changes the vehicle height to lower the vehicle height on the front wheel 32 side in the change control processing. Accordingly, the attitude of the vehicle 1 when the vehicle 1 starts can be made more stable than in the configuration of the third aspect.

In a fifth aspect of the vehicle control system S according to the present embodiment, in addition to the third aspect, the control unit 166 changes the vehicle height to raise the vehicle height on the rear wheel 42 side in the change control processing. Accordingly, the attitude of the vehicle 1 when the vehicle 1 starts can be made more stable than in the configuration of the third aspect.

In a sixth aspect of the vehicle control system S according to the present embodiment, in addition to the third aspect, the control unit 166 changes the vehicle height to lower the vehicle height on the front wheel 32 side and raise the vehicle height on the rear wheel 42 side in the change control processing. Accordingly, the attitude of the vehicle 1 when the vehicle 1 starts can be made more stable than in the configurations of the third to fifth aspects.

In a seventh aspect of the vehicle control system S according to the present embodiment, in addition to any of the first to sixth aspects, the notification unit A presenting notification information notifying that setting in the vehicle 1 is to be changed is further included, and the control unit 166 activates the notification unit A and causes it to present the notification information when both the deceleration operation unit 52 and the starting operation unit 54 are operated while the vehicle 1 is stopped. Accordingly, it is possible to notify the driver that the setting in the vehicle is to be changed.

In an eighth aspect of the vehicle control system S according to the present embodiment, in addition to any of the first to seventh aspects, the deceleration operation unit 52 is the brake pedal 52 and the starting operation unit 54 is the accelerator pedal 54. Accordingly, by pressing the brake pedal 52 and the accelerator pedal 54 at the same time, which correspond to a more general trigger condition for launch control, it is possible to change the damping force and/or the vehicle height prior to execution of the launch control before start.

In a ninth aspect of the vehicle control system S according to the present embodiment, in addition to any of the first to eighth aspects, the vehicle 1 is a side-by-side vehicle. Accordingly, it is possible to cause the side-by-side vehicle that is a small and lightweight off-road automobile to start smoothly and quickly. In addition, it is possible to combine the function such as adjustment of the damping force of the suspensions 30 and 40 and adjustment of the vehicle height as added value with launch control applied to the side-by-side vehicle with good consistency, thereby increasing the fun of driving when the driver drives the side-by-side vehicle.

In the vehicle control device 100a according to the present embodiment, when the determination unit 162 determines that the deceleration operation unit 52 and the starting operation unit 54 are operated while the vehicle 1 is stopped, the control unit 166 performs change control processing that changes one of the damping force of the suspensions 30 and 40 and the vehicle height in a case where the one is controlled and changes both values of the damping force of the suspensions 30 and 40 and the vehicle height in a case where both are controlled, before the vehicle 1 starts. Accordingly, the vehicle 1 can be started smoothly and quickly, as in the configuration of the first aspect.

In the present invention, the types, shapes, arrangements, numbers, and the like of the constituent members are not limited to those in the above embodiment, and it is needless to mention that the constituent elements can be modified as appropriate without departing from the scope of the invention, such as appropriately replacing these constituent elements with other members having equivalent operational effects.

As described above, in the present invention, it is possible to provide a vehicle control system and a vehicle control device that can achieve smooth and quick start of a vehicle with a simple configuration, and because of its general purposes and universal characteristics, applications of the present invention can be expected in a wide range in the field of vehicle control system of motor cycles, four-wheeled automobiles, and the like.

What is claimed is:

1. A vehicle control system comprising:
a deceleration operation unit operated by a driver when a vehicle is to be decelerated;
a starting operation unit operated by the driver when the vehicle is to be started;
suspensions interposed between a vehicle body of the vehicle and wheels; and
a control unit configured to control at least one of a damping force of the suspensions and a vehicle height of the vehicle, wherein
when both the deceleration operation unit and the starting operation unit are operated while the vehicle is stopped, the control unit performs change control processing before the vehicle starts, the change control processing changing one of the damping force and the vehicle height in a case where the one is controlled and changing both of the damping force and the vehicle height in a case where the both elements are controlled.

2. The vehicle control system according to claim 1, further comprising a detection unit configured to detect a physical quantity corresponding to an inclination angle of the vehicle body with respect to a horizontal plane, wherein
the control unit performs the change control processing when an absolute value of the inclination angle obtained by using the physical quantity detected by the detection unit is equal to or lower than a predetermined threshold.

3. The vehicle control system according to claim 2, wherein
the suspensions include a first suspension interposed between the vehicle body and a front wheel of the wheels and a second suspension interposed between the vehicle body and a rear wheel of the wheels, and
in the change control processing, the control unit increases a damping force of the first suspension and increases a damping force of the second suspension.

4. The vehicle control system according to claim 3, wherein the control unit changes the vehicle height to lower a vehicle height on a side of the front wheel in the change control processing.

5. The vehicle control system according to claim 3, wherein the control unit changes the vehicle height to raise a vehicle height on a side of the rear wheel in the change control processing.

6. The vehicle control system according to claim 3, wherein the control unit changes the vehicle height to lower the vehicle height on the side of the front wheel and raise the vehicle height on the side of the rear wheel in the change control processing.

7. The vehicle control system according to claim 1, further comprising a notification unit configured to present notification information notifying that setting in the vehicle is to be changed, wherein
the control unit activates the notification unit and causes the notification unit to present the notification information when both the deceleration operation unit and the starting operation unit are operated while the vehicle is stopped.

8. The vehicle control system according to claim 1, wherein the deceleration operation unit is a brake pedal, and the starting operation unit is an accelerator pedal.

9. The vehicle control system according to claim 1, wherein the vehicle is a side-by-side vehicle.

10. A vehicle control device comprising:
a first input unit to which first information indicating an operation amount of a deceleration operation unit operated by a driver when a vehicle is to be decelerated is input;
a second input unit to which second information indicating an operation amount of a starting operation unit operated by the driver when the vehicle is to be started is input;
a third input unit to which third information indicating a vehicle speed of the vehicle is input;
a determination unit configured to determine whether the deceleration operation unit and the starting operation unit are operated while the vehicle is stopped, by using the first information, the second information, and the third information; and
a control unit configured to control at least one of a damping force of suspensions interposed between a vehicle body of the vehicle and wheels and a vehicle height of the vehicle, wherein
when the determination unit determines that the deceleration operation unit and the starting operation unit are operated while the vehicle is stopped, the control unit performs change control processing before the vehicle starts, the change control processing changing one of the damping force and the vehicle height in a case where the one is controlled and changing both of the damping force and the vehicle height in a case where the both elements are controlled.
